(19) United States
(12) Patent Application Publication
(10) Pub. No.: US 2023/0421458 A1
(43) Pub. Date: Dec. 28, 2023

(54) LEARNING DATA EXTRACTING APPARATUS, INFERENCE APPARATUS, AND LEARNING DATA EXTRACTING METHOD

(71) Applicant: NEC Corporation, Tokyo (JP)

(72) Inventors: Yoshiaki SAKAE, Tokyo (JP); Hiroki TAGATO, Tokyo (JP); Takashi KONASHI, Tokyo (JP); Jun NISHIOKA, Tokyo (JP); Masanao NATSUMEDA, Tokyo (JP); Yuji KOBAYASHI, Tokyo (JP); Jun KODAMA, Tokyo (JP); Etsuko ICHIHARA, Tokyo (JP)

(73) Assignee: NEC Corporation, Tokyo (JP)

(21) Appl. No.: 18/213,753

(22) Filed: Jun. 23, 2023

(30) Foreign Application Priority Data
Jun. 28, 2022 (JP) 2022-103929

(51) Int. Cl. H04L 41/16; H04L 41/0631; G06N 3/088; G06N 3/09

(52) U.S. Cl. CPC H04L 41/16; H04L 41/0631; G06N 3/088; G06N 3/09

(57) ABSTRACT

To extract data-for-machine-leaning so as to enable accurate detection of an abnormality while reducing normal state patterns in a mobile network. A learning data extracting apparatus includes: an issuing section that issues a network service use request which is to be processed by cooperation of a plurality of communication apparatuses constituting C-plane; an obtaining section that obtains, as pieces of candidate learning data, time series data of information relating to the plurality of communication apparatuses; and an extracting section that extracts, as data-for-machine-leaning, a piece of candidate learning data with which the process in response to the network service use request has been successfully ended, from among the pieces of candidate learning data.

This Nonprovisional application claims priority under U.S.C. § 119 on Patent Application No. 2022-103929 filed in Japan on Jun. 28, 2022, the entire contents of which are hereby incorporated by reference.

### TECHNICAL FIELD

The present invention relates to a learning data extracting apparatus, an inference apparatus, and a learning data extracting method.

### BACKGROUND ART

Conventionally, there has been developed a technique for detecting an abnormality in a system. As technologies related to this, there are inventions disclosed in Patent Literatures 1 and 2 below.

Patent Literature 1 discloses an abnormality detecting method executed by an abnormality detection apparatus which detects whether or not an abnormality is present in communication within a monitoring target or communication between a monitoring target and a network to which the monitoring target is connected.

Patent Literature 2 discloses an abnormality detection model learning apparatus including: an input-data-for-learning generating section that generates input data for learning, on the basis of communication status information including one or more items indicating communication statuses of respective base stations when communication is normal in the base stations; and a model learning section that inputs the input data to a dimension reduction algorithm and updates a parameter of the dimension reduction algorithm on the basis of output data from the dimension reduction algorithm and the input data so as to carry out learning for an abnormality detection model.

### CITATION LIST

### Patent Literature

[Patent Literature 1]

Japanese Patent Application Publication, Tokukai, No. 2019-110513

[Patent Literature 2]

Japanese Patent Application Publication, Tokukai, No. 2021-078076

### SUMMARY OF INVENTION

### Technical Problem

Patent Literature 1 relates to detection of an abnormality in control systems of, e.g., factories, plants, and critical infrastructures. Unlike a mobile network, the control system has limited normal states. Thus, it is possible to carry out abnormality detection in the control system with high accuracy. This technique, however, cannot be applied to the mobile network, which is a complicated system.

Meanwhile, Patent Literature 2 relates to abnormality detection in a mobile network. The mobile network, which includes a control plane and a user plane, has a countless number of normal state patterns. Therefore, false detection or missing of an abnormality occur frequently. Thus, a method for reducing the normal state patterns in the mobile network to reduce false detection and missing of an abnormality is required.

An example aspect of the present invention was made in view of the above problems. An example object of the present invention is to provide a technique of extracting data-for-machine-leaning so as to enable accurate detection of an abnormality while reducing normal state patterns in a mobile network.

### Solution to Problem

A learning data extracting apparatus in accordance with an example aspect of the present invention includes at least one processor, the at least one processor being configured to execute: a process of issuing a network service use request which is to be processed by cooperation of a plurality of communication apparatuses constituting a control plane; a process of obtaining, as pieces of candidate learning data, time series data of information relating to the plurality of communication apparatuses, the time series data being obtained in a period in which a process in response to the network service use request is carried out; and a process of extracting, as data-for-machine-leaning, a piece of candidate learning data with which the process in response to the network service use request has been successfully ended, from among the pieces of candidate learning data.

An inference apparatus in accordance with an example aspect of the present invention includes at least one processor, the at least one processor being configured to execute: a process of generating a learned model by carrying out machine learning with use of time series data of information relating to a plurality of communication apparatuses constituting a control plane, the time series data being obtained in a period in which a process in response to a network service use request to be processed by cooperation of the plurality of communication apparatuses is carried out; and a process of determining states of the plurality of communication apparatuses by inputting the time series data to the learned model.

A learning data extracting method in accordance with an example aspect of the present invention includes: issuing a network service use request which is to be processed by cooperation of a plurality of communication apparatuses constituting a control plane; obtaining, as pieces of candidate learning data, time series data of information relating to the plurality of communication apparatuses, the time series data being obtained in a period in which a process in response to the network service use request is carried out; and extracting, as data-for-machine-leaning, a piece of candidate learning data with which the process in response to the network service use request has been successfully ended, from among the pieces of candidate learning data.

### Advantageous Effects of Invention

In accordance with an example aspect of the present invention, it is possible to extract data-for-machine-leaning so as to enable accurate detection of an abnormality while reducing normal state patterns in a mobile network.

### BRIEF DESCRIPTION OF DRAWINGS

FIG. 1 is a block diagram illustrating an example of a configuration of a learning data extracting apparatus in accordance with a first example embodiment of the present invention.

FIG. 2 is a flowchart illustrating a flow of a processing method to be executed by the learning data extracting apparatus in accordance with the first example embodiment of the present invention.

FIG. 3 is a block diagram illustrating an example of a configuration of a learning data extracting system in accordance with the first example embodiment of the present invention.

FIG. 4 is a block diagram illustrating an example of a configuration of an inference apparatus in accordance with the first example embodiment of the present invention.

FIG. 5 is a flowchart illustrating a flow of a processing method to be executed by the inference apparatus in accordance with the first example embodiment of the present invention.

FIG. 6 is a view illustrating a mobile network including a plurality of communication apparatuses constituting a control plane.

FIG. 7 is a sequence diagram illustrating connection for communication.

FIG. 8 is a sequence diagram illustrating hand-over.

FIG. 9 is a block diagram illustrating an example of a configuration of a learning data extracting system in accordance with a second example embodiment of the present invention.

FIG. 10 is a view illustrating an example (example 1) of statistical information relating to RRC connection.

FIG. 11 is a view illustrating an example (example 2) of the statistical information relating to the RRC connection.

FIG. 12 is a view illustrating an example (example 1) of statistical information relating to wireless communication.

FIG. 13 is a view illustrating an example (example 2) of the statistical information relating to the wireless communication.

FIG. 14 is a block diagram illustrating a configuration of a computer functioning as the learning data extracting apparatus in accordance with each of the example embodiments.

### DESCRIPTION OF EMBODIMENTS

### Background of Invention

Along with advancement of 5th generation mobile communication system (5G) and 6th generation mobile communication system (6G), it becomes difficult to detect a failure or an abnormality in a mobile network and to determine a cause of the failure or abnormality. This happens due to, e.g., advancement in performance of a device, virtualization, increase in the number of connected terminals, and diversification of types of connection terminals such as IoT tools.

Abnormality detection based on a threshold value has been carried out conventionally. Such abnormality detection is effective to simple abnormality detection, but is insufficient to complicated abnormality detection. Thus, abnormality detection based on machine learning is carried out.

Further, normal operation is general in an infrastructure system such as a mobile network, and therefore it is difficult to collect data of abnormal states. In order to deal with this, there is an approach to carry out learning with use of data of normal states and detect an abnormality on the basis of a deviation therefrom.

### First Example Embodiment

### Learning Data Extracting Apparatus 1 in Accordance with First Example Embodiment

The following description will discuss a first example embodiment of the present invention in detail with reference to the drawings. The present example embodiment is a basic form of example embodiments described later. In this overview, reference numerals in the drawings are assigned, for convenience, to respective elements as an example for easier understanding, and are not intended to limit the present invention to aspects illustrated in the drawings. Further, a direction in which connecting lines between blocks in, for example, the drawings to be referred to in the following description extend includes both a single direction and two directions. A unidirectional arrow schematically illustrates a flow of a main signal (data) and is not intended to exclude bidirectionality. Moreover, a point of connection between an input and an output of each of the blocks in the drawings may be configured to be provided with a port or an interface. However, such a configuration is not illustrated.

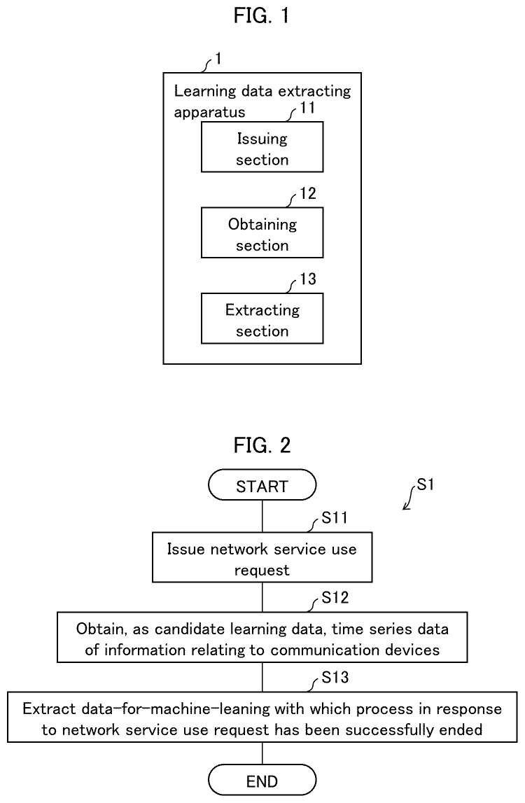

FIG. 1 is a block diagram illustrating an example of a configuration of a learning data extracting apparatus in accordance with a first example embodiment of the present invention. As shown in FIG. 1, the learning data extracting apparatus 1 in accordance with the present example embodiment includes an issuing section 11, an obtaining section 12, and an extracting section 13.

The issuing section 11 issues a network service use request which is to be processed by cooperation of a plurality of communication apparatuses constituting a control plane. The control plane corresponds to C-plane such as 5th generation mobile communication system (5G) core network (hereinafter, referred to as “5GC”) or 4th generation mobile communication system (4G) defined by 3rd generation mobile communication system partnership project (3GPP).

5GC employs an architecture which separately processes a control plane (C-plane) and a user plane (U-plane). The C-plane is designed for communication of control signals for, e.g., establishment of communication, whereas the U-plane is designed for communication of user data. The U-plane side, which includes a countless number of applications and services, virtually has a countless number of communication patterns. Meanwhile, the C-plane side, which is used for communication of control signals standardized by 3GPP or the like, has a limited number of communication patterns. The present example embodiment uses, as a subject of learning and inference, information relating to a plurality of communication apparatuses constituting the C-plane, thereby reducing variations of normal states.

The network service use request is, for example, a request for Radio Resource Control (RRC) connection, hand-over, or the like. This request is processed by cooperation of the plurality of communication apparatuses constituting the C-plane, as will be described later.

The obtaining section 12 obtains, as pieces of candidate learning data, time series data of information relating to the plurality of communication apparatuses, the time series data being obtained in a period in which a process in response to the network service use request is carried out. The information relating to the plurality of communication apparatuses is, for example, traffic information of the plurality of communication apparatuses or statistical information relating to processes of the plurality of communication apparatuses. The obtaining section 12 obtains these pieces of information at predetermined time intervals as time series data. The time series data thus obtained is used as the pieces of candidate learning data.

The extracting section 13 extracts, as data-for-machine-leaning, a piece of candidate learning data with which the process in response to the network service use request has been successfully ended, from among the pieces of candidate learning data. The successful ending of the process in response to the network service use request excludes, e.g., (i) a case where an error code is reported in response to the request and the process is brought into abnormal ending or (ii) a case where no response is given in response to the request and the process is ended by time-out.

The extracting section 13 extracts, as data-for-machine-leaning used by the later-described inference apparatus to carry out machine learning, learning data with which the process in response to the request has been successfully ended. Note that the data-for-machine-leaning is used for unsupervised learning for abnormality detection. Further, learning data with which the process in response to the request has been abnormally ended may be included also in the data-for-machine-learning, and such data-for-machine-learning may be used for supervised learning for state classification.

### Effects of Learning Data Extracting Apparatus 1

As discussed above, the learning data extracting apparatus 1 in accordance with the present example embodiment is configured such that: the obtaining section 12 obtains, as pieces of candidate learning data, time series data of information relating to the plurality of communication apparatuses constituting the C-plane; and the extracting section 13 extracts, as data-for-machine-leaning, a piece of candidate learning data with which a process in response to a network service use request has been successfully ended, from among the pieces of candidate learning data. Consequently, the learning data extracting apparatus 1 can extract the data-for-machine-leaning so as to enable accurate detection of an abnormality while reducing normal state patterns in a mobile network.

### Flow of Processing Method of Learning Data Extracting Apparatus 1

The following will describe, with reference to FIG. 2, a flow of a processing method to be executed by the learning data extracting apparatus 1 configured as above. FIG. 2 is a flowchart illustrating a flow of the processing method to be executed by the learning data extracting apparatus 1 in accordance with the first example embodiment. As shown in FIG. 2, the processing method S1 includes steps S11 to S13.

First, the issuing section 11 issues a network service use request which is to be processed by cooperation of the plurality of communication apparatuses constituting the control plane (S11). The present example embodiment uses, as a subject of learning and inference, information relating to a plurality of communication apparatuses constituting the C-plane, thereby reducing variations of normal states.

Then, the obtaining section 12 obtains, as pieces of candidate learning data, time series data of information relating to the plurality of communication apparatuses, the time series data being obtained in a period in which a process in response to the network service use request is carried out (S12). The information relating to the plurality of communication apparatuses is, for example, traffic information of the plurality of communication apparatuses or statistical information relating to processes of the plurality of communication apparatuses. The obtaining section 12 obtains these pieces of information at predetermined time intervals as time series data. The time series data thus obtained is used as the pieces of candidate learning data.

Lastly, the extracting section 13 extracts, as data-for-machine-leaning, a piece of candidate learning data with which the process in response to the network service use request has been successfully ended, from among the pieces of candidate learning data (S13). The successful ending of the process in response to the network service use request excludes, e.g., (i) a case where an error code is reported in response to the request and the process is brought into abnormal ending or (ii) a case where no response is given in response to the request and the process is ended by time-out.

### Effects of Processing Method of Learning Data Extracting Apparatus 1

As discussed above, the processing method of the learning data extracting apparatus 1 in accordance with the present example embodiment obtains, as pieces of candidate learning data, time series data of information relating to the plurality of communication apparatuses constituting the C-plane, and extracts, as data-for-machine-leaning, a piece of candidate learning data with which a process in response to a network service use request has been successfully ended, from among the pieces of candidate learning data. Consequently, the processing method can extract the data-for-machine-leaning so as to enable accurate detection of an abnormality while reducing normal state patterns in a mobile network.

### Learning Data Extracting System 100 in Accordance with First Example Embodiment

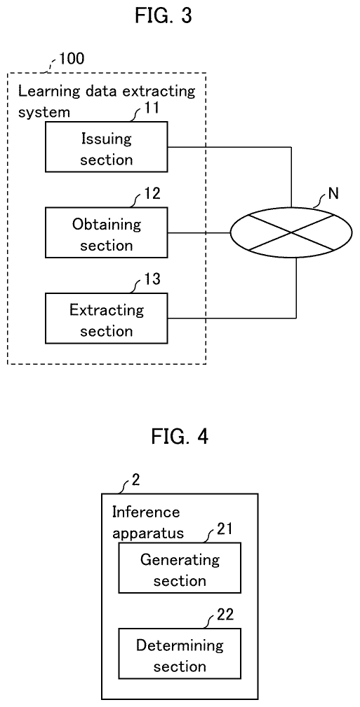

FIG. 3 is a block diagram illustrating an example of a configuration of a learning data extracting system 100 in accordance with the first example embodiment of the present invention. As shown in FIG. 3, the learning data extracting system 100 in accordance with the present example embodiment includes an issuing section 11, an obtaining section 12, and an extracting section 13.

In an example, the issuing section 11, the obtaining section 12, and the extracting section 13 are configured to be communicable with each other through a network N. Here, for example, a specific configuration of the network N can be wireless Local Area Network (LAN), wired LAN, Wide Area Network (WAN), a public network, a mobile data communication network, or any combination of these networks. This, however, by no means, limits the present example embodiment.

Note that the functions of the learning data extracting system 100 may be implemented in a cloud. For example, the issuing section 11 may constitute a single apparatus and the obtaining section 12 and the extracting section 13 may constitute a single apparatus. These sections may be implemented in a single apparatus or in respective different apparatuses. For example, in a case where these sections are implemented in respective different apparatuses, transmission and reception of information is carried out through the network N and the process advances.

The issuing section 11 issues, through the network N, a network service use request which is to be processed by cooperation of the plurality of communication apparatuses constituting the control plane. The present example embodiment uses, as a subject of learning and inference, information relating to the plurality of communication apparatuses constituting the C-plane, thereby reducing variations of normal states.

Through the network N, the obtaining section 12 obtains, as pieces of candidate learning data, time series data of information relating to the plurality of communication apparatuses, the time series data being obtained in a period in which a process in response to the network service use request is carried out. The information relating to the plurality of communication apparatuses is, for example, traffic information of the plurality of communication apparatuses or statistical information relating to processes of the plurality of communication apparatuses. The obtaining section 12 obtains these pieces of information at predetermined time intervals as time series data. The time series data thus obtained is used as pieces of candidate learning data.

The extracting section 13 extracts, as data-for-machine-leaning, a piece of candidate learning data with which the process in response to the network service use request has been successfully ended, from among the pieces of candidate learning data obtained through the network N. The successful ending of the process in response to the network service use request excludes, e.g., (i) a case where an error code is reported in response to the request and the process is brought into abnormal ending or (ii) a case where no response is given in response to the request and the process is ended by time-out.

As discussed above, the learning data extracting system 100 in accordance with the present example embodiment is configured such that: the obtaining section 12 obtains, as pieces of candidate learning data, time series data of information relating to the plurality of communication apparatuses constituting the C-plane; and the extracting section 13 extracts, as data-for-machine-leaning, a piece of candidate learning data with which a process in response to the network service use request has been successfully ended, from among the pieces of candidate learning data. Consequently, the learning data extracting system 100 can extract the data-for-machine-leaning so as to enable accurate detection of an abnormality while reducing normal state patterns in a mobile network.

### Inference Apparatus 2 in Accordance with First Example Embodiment

FIG. 4 is a block diagram illustrating an example of a configuration of the inference apparatus 2 in accordance with the first example embodiment of the present invention. As shown in FIG. 4, the inference apparatus 2 in accordance with the present example embodiment includes a generating section 21 and a determining section 22.

The generating section 21 generates a learned model by carrying out machine learning with use of time series data of information relating to a plurality of communication apparatuses constituting a control plane, the time series data being obtained in a period in which a process in response to a network service use request to be processed by cooperation of the plurality of communication apparatuses is carried out.

The model is, for example, a model generated by causing a neural network to carry out deep learning. Examples of the neural network include Convolutional Neural Network (CNN) and Recurrent Neural Network (RNN). Note that the model is not limited to these configuration, and may alternatively be obtained by any of other kinds of machine learning such as Support Vector Machine (SVM) or by a combination of any of other kinds of machine learning and the neural network. Note that the model can be expressed also as an inference model, an estimation model, or an identification mode, for example.

The determining section 22 determines states of the plurality of communication apparatuses by inputting the time series data to the learned model. For example, the generating section 21 generates a learned model by carrying out machine learning with use of the time series data of the information relating to the plurality of communication apparatuses. Then, the determining section 22 inputs, to the learned model, current time series data of the information relating to the plurality of communication apparatuses, and determines states of the plurality of communication apparatuses.

### Effects of Inference Apparatus 2

As discussed above, the inference apparatus 2 in accordance with the present example embodiment is configured such that the determining section 22 inputs the time series data to the learned model to determine the states of the plurality of communication apparatuses. Here, the learned model is a model generated as a result of machine learning carried out with use of time series data of information relating to a plurality of communication apparatuses constituting C-plane, the time series data being obtained in a period in which a process in response to a network service use request to be processed by cooperation of the plurality of communication apparatuses is carried out.

Thus, normal state patterns in the mobile network have been reduced, and the generated model has been sufficiently trained with the normal state patterns. This enables the inference apparatus 2 to carry out abnormality detection with high accuracy.

### Flow of Processing Method of Inference Apparatus 2

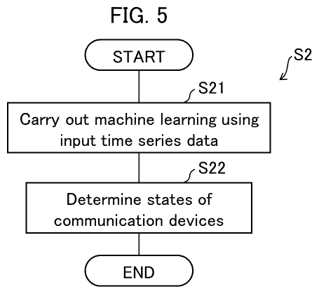

The following will describe, with reference to FIG. 5, a flow of a processing method to be executed by the inference apparatus 2 configured as above. FIG. 5 is a flowchart illustrating a flow of a processing method carried out by the inference apparatus 2 in accordance with the present example embodiment. As shown in FIG. 5, the processing method S2 of the inference apparatus 2 includes steps S21 and S22.

First, the generating section 21 generates a learned model by carrying out machine learning with use of time series data of information relating to a plurality of communication apparatuses constituting a control plane, the time series data being obtained in a period in which a process in response to a network service use request to be processed by cooperation of the plurality of communication apparatuses is carried out (S21).

Then, the determining section 22 determines states of the plurality of communication apparatuses by inputting the time series data to the learned model (S22).

### Second Example Embodiment

### Plurality of Communication apparatuses Constituting C-Plane

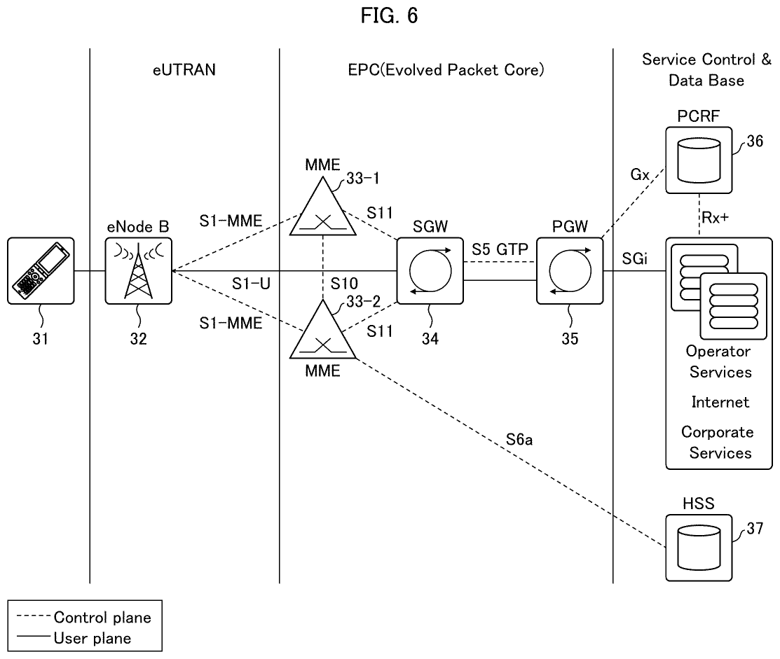

Prior to a description of a second example embodiment of the present invention, a description of a plurality of communication apparatuses constituting C-plane will be given. FIG. 6 is a view illustrating a mobile network including the plurality of communication apparatuses constituting the C-plane. As shown in FIG. 6, the mobile network includes User Equipment (UE) 31, eNodeB (base station) 32, Mobility Management Entities (MMEs) 33-1 and 33-2, Serving GateWay (SGW) 34, Packet data network GateWay (PGW) 35, Policy and Charging Rule control Function (PCRF) 36, and Home Subscriber Server (HSS) 37. Note that, in FIG. 6, the C-plane is indicated by broken lines and the U-plane is indicated by solid lines.

The UE 31 is a terminal apparatus such as a smartphone, and is connected to the eNodeB (base station) 32 on evolved Universal Terrestrial Radio Access Network (eUTRAN). Further, the eNodeB 32 is connected to Evolved Packet Core (EPC) through an S1 interface. Note that the broken lines and solid lines between the nodes indicate interfaces between the nodes.

The EPC includes the MMEs 33-1 and 33-2, the SGW 34, and the PGW 35. Each of the MMEs 33-1 and 33-2 is a node which has the eNodeB (base station) housed therein and which provides mobility control and/or the like.

The SGW 34 is an in-zone packet gateway having a 3GPP access system housed therein. The PGW 35 is a connection point with PDN, and is a gateway which carries out, e.g., assignment of an IP address, transferring of a packet to the SGW 34, and/or the like. Hereinafter, the SGW and PGW may also be called “S/P-GW” collectively.

The Service Control & Data Base includes the PCRF 36 and the HSS 37. The PCRF 36 is a node which carries out control for Quality of Service (QoS) of transferring of user data and charging. The HSS 37 is a subscriber information database in a 3GPP mobile communication network, and manages authentication information and in-zone information.

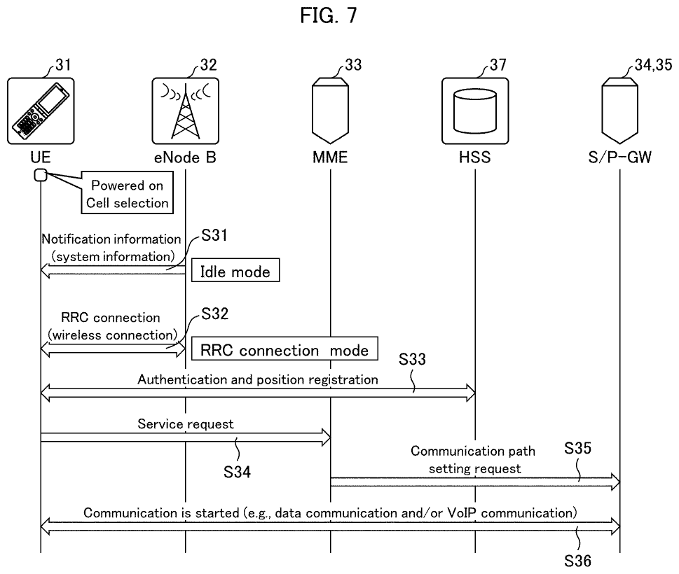

FIG. 7 is a sequence diagram illustrating connection for communication. First, when the UE 31 is powered on, cell selection is started. When notification information (system information) is transmitted from the eNodeB 32 to the UE 31 (S31), RRC connection (wireless connection) is carried out (S32). Consequently, Idle mode transitions to RRC Connection mode.

Then, when authentication and positon registration are carried out between the UE 31 and the HSS 37 (S33), the UE 31 transmits a service request to the MME 33 (S34). When the MME 33 receives the service request from the UE 31, the MME 33 transmits a communication path setting request to the S/P-GW 34, 35 (S35). When a communication path is set, communication such as data communication and/or VoIP communication is started (S36).

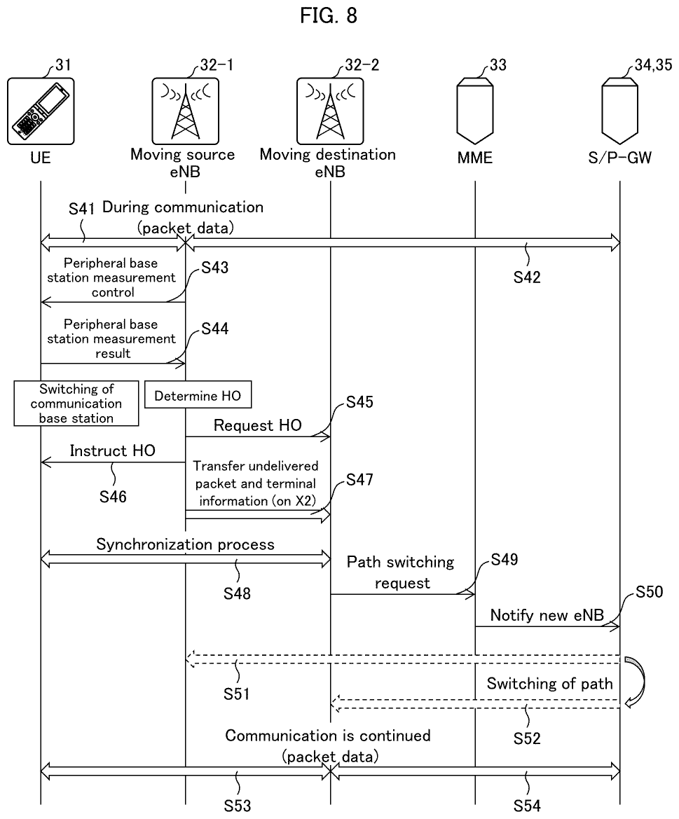

FIG. 8 is a sequence diagram illustrating hand-over. While packet data is communicated between the UE 31 and the S/P-GW 34, 35 (S41, S42), if a moving source eNB 32-1 detects that the UE 31 is about to exit the cell, a peripheral base station measurement control is started (S43).

When the moving source eNB 32-1 receives a peripheral base station measurement result from the UE 31 (S44), the moving source eNB 32-1 transmits a hand-over (HO) request to a moving destination eNB 32-2 (S45). Further, the moving source eNB 32-1 transmits the HO instruction to the UE 31 (S46). Then, when the moving source eNB 32-1 transfers an undelivered packet(s) and terminal information to the moving destination eNB 32-2 (S47), a synchronization process is carried out between the UE 31 and the moving destination eNB 32-2 (S48).

Subsequently, the moving destination eNB 32-2 transmits a path switching request to the MME 33 (S49). When the MME 33 receives the path switching request from the moving destination eNB 32-2, the MME 33 notifies the S/P-GW 34, 35 of new eNB (S50). Then, when switching of the path is carried out (S51, S52), the UE 31 continues communication of packet data with the S/P-GW 34, 35 via the moving destination eNB 32-2 (S53, S54).

### Example of Configuration of Learning Data Extracting System 100A in Accordance with Second Example Embodiment

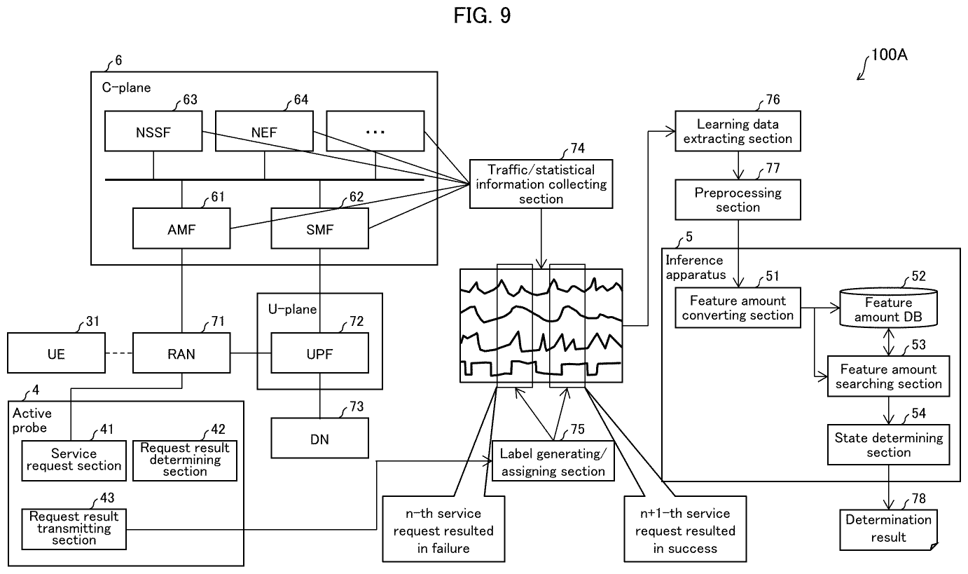

FIG. 9 is a view illustrating a configuration of a learning data extracting system 100A in accordance with the second example embodiment of the present invention. The learning data extracting system 100A in accordance with the present example embodiment includes an active probe 4, an inference apparatus 5, C-plane 6, UE 31, a RAN 71, a UPF 72, a DN 73, a traffic/statistical information collecting section 74, a label generating/assigning section 75, a learning data extracting section 76, and a preprocessing section 77.

The active probe 4 includes a service request section 41, a request result determining section 42, and a request result transmitting section 43. The service request section 41 has a configuration that realizes an issuing section in the present example embodiment. The traffic/statistical information collecting section 74 has a configuration that realizes an obtaining section in the present example embodiment. The learning data extracting section 76 has a configuration that realizes an extracting section in the present example embodiment.

The RAN 71 is a base station that uses new Radio Access Technology (RAT). Further, the RAN 71 may be Access Network (AN) that is a base station using non-3GPP access. The AN is, for example, an access point such as WiFi (registered trademark).

5GC is constituted by Network Functions (NFs) such as Access and Mobility Function (AMF) 61, Session Management Function (SMF) 62, Network Slice Selection Function (NSSF) 63, Network Exposure Function (NEF) 64, and User Plane Function (UPF) 72.

The AMF 61 is NF that provides, e.g., authentication, permission, and mobility management of the UE 31, and controls the SMF 62. Further, the SMF 62 is NF that carries out session management of the UE 31, assignment of an IP address, selection and control of the UPF 72 for data transfer, and/or the like. In a case where the UE 31 establishes a plurality of sessions, the AMF 61 can assign different SMFs 62 to the different sessions in order that the SMF 62 can independently manage the sessions and use different functions for the different sessions. In 5GC, the management relating to the UE 31 is carried out by the single AMF 61, and traffic is dealt with by the SMFs 62 for respective network slices.

The NSSF 63 is NF which constructs a plurality of logical networks, i.e., network slices, having different characteristics on a single physical network and which provides specific communication services for the respective network slices.

The NEF 64 is NF which publishes: a series of management functions such as addition and deletion of a group and a member and various alternations; and a function of dynamically managing group data.

The UPF 72 is NF which functions as an external Protocol Data Unit (PDU) for interconnection with Data Network (DN) 73 and which carries out packet routing, forwarding, and/or the like.

The DN 73 is a data network outside 5GC, and includes a wide area network such as the Internet and a narrow area network such as LAN.

The active probe 4 and the RAN 71 are connected with each other through wired connection. The service request section 41 issues a network service use request which is to be processed by cooperation of the plurality of communication apparatuses constituting the C-plane explained with reference to FIGS. 6 to 8. The network service use request is a request similar to the one issued by the UE 31. Various kinds of requests used by the UE 31 are periodically issued from the service request section 41.

The request result determining section 42 receives, via the RAN 71, a response to the network service use request. In a case where the process in response to the network service use request is successfully ended, the active probe 4 is notified of the successful ending.

Meanwhile, in a case where the process in response to the network service use request is abnormally ended, the active probe 4 receives a notification including an error code. The request result determining section 42 refers to the error code to determine the abnormal state of the control plane. In a case where no response is given in response to the network service use request, this is determined as time-out, for example.

The request result transmitting section 43 transmits, to the label generating/assigning section 75, a determination result given by the request result determining section 42. The determination result includes information indicating, e.g., successful ending of the process in response to the network service use request, abnormal ending of the process in response to the network service use request, an abnormal state of the control plane in the case of the abnormal ending, or no response to the network service use request.

The traffic/statistical information collecting section 74 monitors the NFs in the C-plane 6, and collects information relating to the plurality of communication apparatuses. The traffic/statistical information collecting section 74 collects, as the information relating to the plurality of communication apparatuses, traffic information of the plurality of communication apparatuses, for example. The traffic information is flow information indicating, e.g., the size, cycle, and/or the like of traffic (information amount).

The traffic/statistical information collecting section 74 may be configured to collect, as the information relating to the plurality of communication apparatuses, statistical information relating to processes of the plurality of communication apparatuses, for example. The statistical information indicates, for example, the accumulative number of successes, a success rate, an average processing time, and/or the number of connections in the RRC connection.

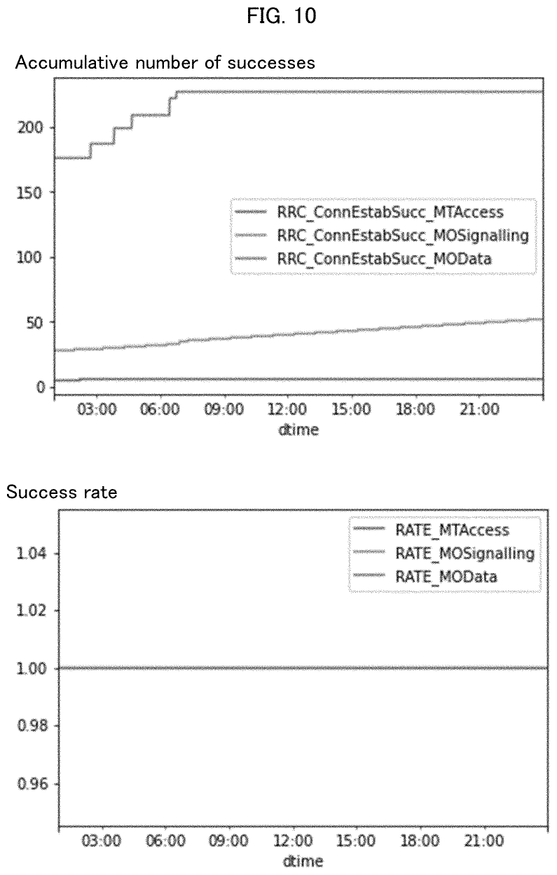

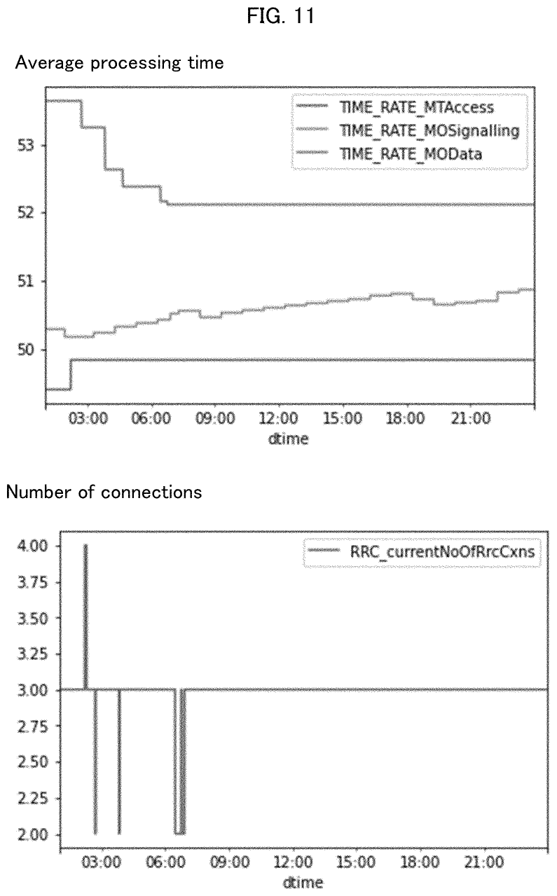

Each of FIGS. 10 and 11 is a view illustrating an example of the statistical information relating to the RRC connection. A view in the upper part of FIG. 10 indicates the accumulative number of successes in the RRC connection. The horizontal axis indicates a clock time, whereas the vertical axis indicates the accumulative number of successes at a certain clock time. The view in the upper part of FIG. 10 indicates the accumulative numbers of successes of MTAccess, MOSignaling, and MOData. MTAccess indicates a response to calling from a terminal in an idling state. MOSignaling indicates position information registration and/or connection message by the terminal. MOData indicates restoration of the terminal from the idling state caused by, e.g., data transmission.

A view in the lower part of FIG. 10 indicates the success rate in the RRC connection. The horizontal axis indicates a clock time, whereas the vertical axis indicates the success rate at a clock time. The view in the lower part of FIG. 10 indicates the success rates of MTAccess, MOSignaling, and MOData.

A view in the upper part of FIG. 11 indicates the average processing time in the RRC connection. The horizontal axis indicates a clock time, whereas the vertical axis indicates the average processing time at a certain clock time. The view in the upper part of FIG. 11 indicates the average processing times of MTAccess, MOSignaling, and MOData.

A view in the lower part of FIG. 11 indicates the number of connections in the RRC connection. The horizontal axis indicates a clock time, whereas the vertical axis indicates the number of connections at a certain clock time.

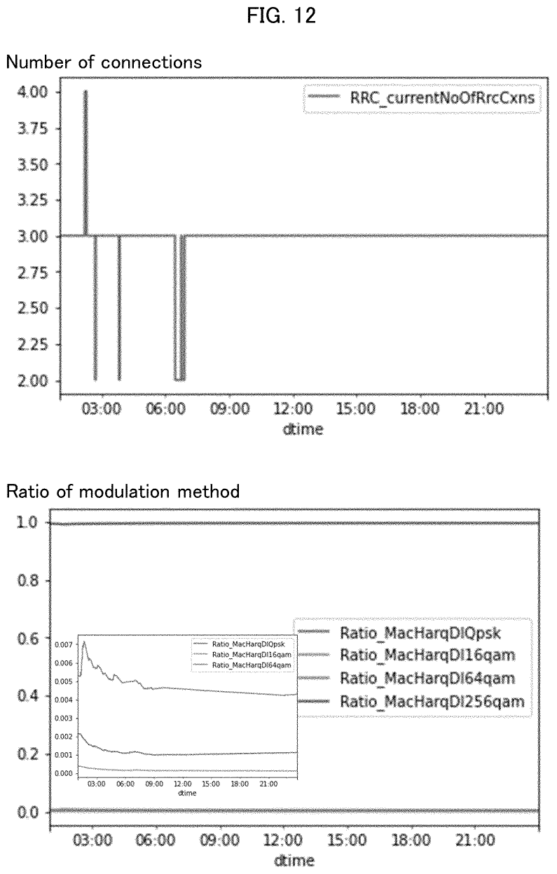

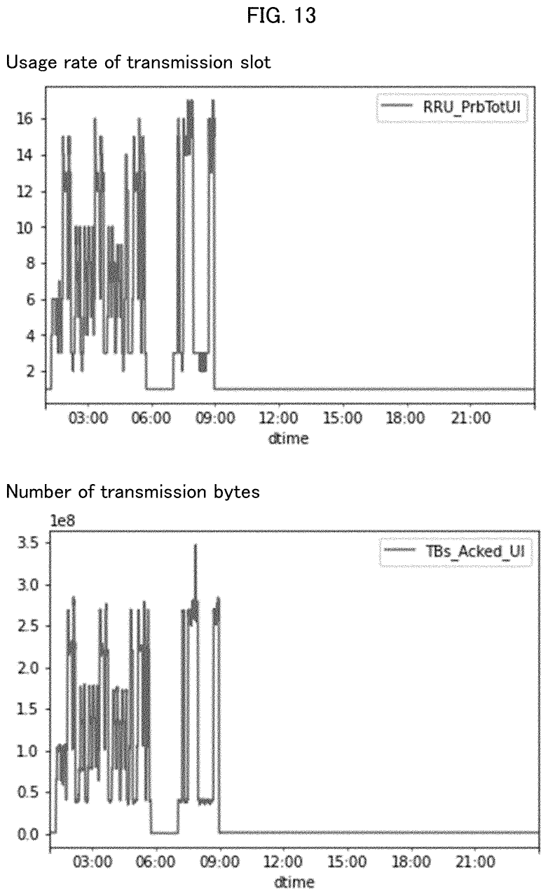

Each of FIGS. 12 and 13 is a view illustrating an example of the statistical information relating to wireless communication. A view in the upper part of FIG. 12 indicates the number of connections. The horizontal axis indicates a clock time, whereas the vertical axis indicates the number of connections at a certain clock time.

A view in the lower part of FIG. 12 indicates a ratio of a modulation method to be used. The horizontal axis indicates a clock time, whereas the vertical axis indicates the modulation method at a certain clock time. The view in the lower part of FIG. 12 indicates cases of QPSK, 16QAM, 64QAM, and 256QAM, which are four modulation methods. In most cases, as the radio wave environment is degraded, a modulation method with a smaller amount of information is used. Thus, the modulation method can be an indicator indicating a communication environment of the terminal.

A view in the upper part of FIG. 13 indicates a usage rate of a transmission slot. The horizontal axis indicates a clock time, whereas the vertical axis indicates the usage rate of the transmission slot at a certain clock time. A view in the lower part of FIG. 13 indicates in the number of transmission bytes. The horizontal axis indicates a clock time, whereas the vertical axis indicates the number of transmission bytes at a certain clock time.

Referring back to FIG. 9, the traffic/statistical information collecting section 74 obtains, as the time series data, traffic information at each clock time or a combination of any of the pieces of statistical information shown in FIGS. 10 to 13. The time series data is divided by the learning data extracting section 76 into pieces for processes in response to network service use requests, and the divided pieces of data are used as pieces of candidate learning data.

Illustrated in FIG. 9 is a case where an n-th service request resulted in failure. Thus, the request result transmitting section 43 transmits, to the label generating/assigning section 75, information indicating that the n-th service request has been abnormally ended and information relating to the abnormal state (the cause of the abnormality) of the control plane in the abnormal ending. Further, in the case illustrated in FIG. 9, an n+1-th service request resulted in success. Thus, the request result transmitting section 43 transmits, to the label generating/assigning section 75, information indicating that the n+1-th service request has been successfully ended.

In accordance with the results of the requests received from the request result transmitting section 43, the label generating/assigning section 75 generates labels for the respective service requests, and assigns the labels to the service requests. For example, the label generating/assigning section 75 may generate a label so as to allow identification of whether the request resulted in success or failure and to allow identification of the state of the C-plane when the request resulted in failure.

In a case where unsupervised learning is carried out by the inference apparatus 5, the learning data extracting section 76 extracts, as data-for-machine-leaning, a piece of candidate learning data with which a process in response to a network service use request has been successfully ended, from among the pieces of candidate learning data.

Meanwhile, in a case where supervised learning is carried out by the inference apparatus 5, the learning data extracting section 76 may further extract, as data-for-machine-leaning, a piece of candidate learning data with which the process in response to the network service use request has been abnormally ended, from among the pieces of candidate learning data, and may respectively assign, to the data-for-machine-leaning that is the piece of candidate learning data with which the process has been successfully ended and the data-for-machine-leaning that is the piece of candidate learning data with which the process has been abnormally ended, labels each indicating a state of the control plane in response to the network service use request.

Further, the learning data extracting section 76 may be configured not to extract, as data-for-machine-leaning, a piece of candidate learning data among the pieces of candidate learning data with which piece of candidate learning data no response has been given in response to the network service use request. The piece of candidate learning data with which no response has been given in response to the network service use request may be, for example, a piece of candidate learning data with which the process is ended by, e.g., time-out.

The preprocessing section 77 carries out preprocessing on the data-for-machine-leaning extracted by the learning data extracting section 76 so that the data-for-machine-leaning is in a form that can be processed by the inference apparatus 5, and outputs, to the inference apparatus 5, the data-for-machine-leaning having been subjected to the preprocessing.

The inference apparatus 5 includes a feature amount converting section 51, a feature amount data base (DB) 52, a feature amount searching section 53, and a state determining section 54. The feature amount converting section 51 has a configuration that realizes a generating section in the present example embodiment. The state determining section 54 has a configuration that realizes a determining section in the present example embodiment.

The feature amount converting section 51 generates a model by carrying out machine learning with use of the data-for-machine-leaning having been subjected to the preprocessing carried out by the preprocessing section 77. For example, learning of the model is carried out so that a feature amount can be extracted from time series data. Then, when the machine learning of the model is ended, the feature amount converting section 51 uses the model generated by machine learning to convert the time series data into a feature amount, and accumulates the feature amount in the feature amount DB 52.

The time series data and the label assigned by the label generating/assigning section 75 may be used as training data to carry out learning of the model. In this case, with use of the model having been subjected to machine learning, the time series data can be identified as the one with which the process in response to the network service use request resulted in successful end/abnormal end, the one relating to an abnormal state of the control plane in the case of the abnormal ending, the one with which no response has been given in response to the network service use request, or the like.

The feature amount DB 52 is constituted by, e.g., a nonvolatile memory such as a flash memory or hard disk. The feature amount DB 52 sequentially stores feature amounts obtained by conversion carried out by the feature amount converting section 51, and accumulates the feature amounts therein. Each of the feature amounts may additionally include information indicating, e.g., successful ending of the process in response to the network service use request, abnormal ending of the process in response to the network service use request, an abnormal state of the control plane in the case of the abnormal ending, or no response to the network service use request.

The feature amount converting section 51 inputs, to the model having been subjected to machine learning, current time series data of the information relating to the plurality of communication apparatuses, to convert the time series data into a feature amount. Then, the feature amount searching section 53 searches the feature amount stored in the feature amount DB 52.

In a case where there exists a feature amount approximate to the current time series data, the state determining section 54 can determine the current state and/or the like of the C-plane by referring to the information additionally included in the feature amount. Then, the state determining section 54 outputs a determination result 78.

### Another Example Embodiment of Service Request Section 41

Further, the service request section 41 may be configured to adjust an issuance status of a network service use request in accordance with an operation status of one or more pieces of UE 31 that utilize the network service.

For example, the service request section 41 monitors the operation status of the one or more pieces of UE 31, and obtains the issuance status of the one or more pieces of UE 31 for each type of network service use request. Then, in accordance with the issuance status of the one or more pieces of UE 31 for each type of network service use request, the service request section 41 adjusts a status of issuance of a network service use request by the service request section 41 itself.

To be more specific, in accordance with the number of times that the one or more pieces of UE 31 give the network service use request, the service request section 41 adjusts the frequency of issuance of the network service use request. For example, as the number of times that the one or more pieces of UE 31 give the network service use request increases, the service request section 41 increases the number of times that the service request section 41 issues the network service use request. Meanwhile, as the number of times that the one or more pieces of UE 31 give the network service use request decreases, the service request section 41 decreases the number of times that the service request section 41 the network service use request.

Further, the service request section 41 may be configured to adjust an issuance status of the network service use request in accordance with time information. The time information is, for example, a clock time, a time period, and/or a seasonal event. The service request section 41 stores, in advance, a past status of issuance of the network service use request by the one or more pieces of UE 31 in association with a clock time, a time period, a seasonal event, or the like. Then, in accordance with the current clock time, the current time period, the current seasonal event, and/or the like, the service request section 41 adjusts a status of issuance of the network service use request by the service request section 41 itself.

### Effects of Learning Data Extracting System 100A

As discussed above, the learning data extracting section 100 in accordance with the present example embodiment is configured such that: the learning data extracting section 76 respectively assigns, to data-for-machine-leaning that is the piece of candidate learning data with which the process has been successfully ended and data-for-machine-leaning that is the piece of candidate learning data with which the process has been abnormally ended, labels each indicating a state of the control plane in response to the network service use request. Thus, by using a model generated by machine learning involving use of the time series data, the inference apparatus 5 can identify the current state of the control plane in response to the network service use request.

Further, the learning data extracting section 76 does not extract, as data-for-machine-leaning, a piece of candidate learning data among the pieces of candidate learning data with which piece of candidate learning data no response has been given in response to a network service use request. This makes it possible to exclude data which is not suitable as data-for-machine-leaning, thereby enabling the inference apparatus 5 to carry out machine learning more appropriately.

Further, since the service request section 41 adjusts an issuance status of a network service use request in accordance with an operation status of one or more communication terminals that utilize the network service, it is possible to more appropriately adjust the status (frequency) of issuance of a network service use request by the service request section 41 itself.

Further, since the service request section 41 adjusts an issuance status of the network service use request in accordance with time information, it is possible to more appropriately adjust the status (frequency) of issuance of a network service use request by the service request section 41 itself in accordance with an operation status of one or more communication terminals, the operation status being given by the time information.

### Software Implementation Example

Some of or all of the functions of the learning data extracting apparatus 1, the inference apparatus 2, and the learning data extracting system 100, 100A may be realized by hardware such as an integrated circuit (IC chip) or by software.

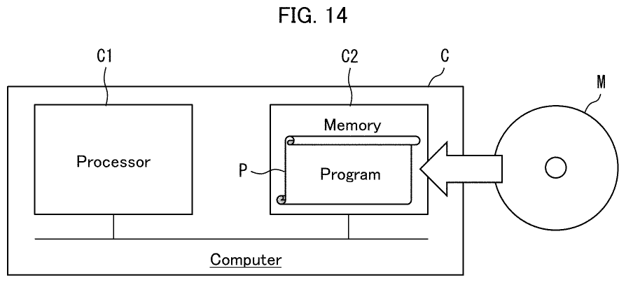

In the latter case, each of the learning data extracting apparatus 1, the inference apparatus 2, and the learning data extracting system 100, 100A is realized by, e.g., a computer that executes instructions of a program that is software realizing the foregoing functions. FIG. 14 shows an example of such a computer (hereinafter, referred to as a “computer C”). The computer C includes at least one processor C1 and at least one memory C2. The memory C2 has a program P stored therein, the program P causing the computer C to operate as the learning data extracting apparatus 1, the inference apparatus 2, and the learning data extracting system 100, 100A. In the computer C, the processor C1 reads and executes the program P from the memory C2, thereby realizing the functions of the learning data extracting apparatus 1, the inference apparatus 2, and the learning data extracting system 100, 100A.

The processor C1 may be, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a microcontroller, or a combination of any of them. The memory C2 may be, for example, a flash memory, Hard Disk Drive (HDD), Solid State Drive (SSD), or a combination of any of them.

The computer C may further include a RAM in which the program P is loaded when executed and various data is temporarily stored. In addition, the computer C may further include a communication interface via which the computer C transmits/receives data to/from another apparatus. The computer C may further include an input-output interface via which the computer C is connected to an input-output device such as a keyboard, a mouse, a display, and/or a printer.

The program P can be stored in a non-transitory, tangible storage medium M capable of being read by a computer C. Examples of the storage medium M encompass a tape, a disk, a card, a memory, a semiconductor memory, and a programmable logic circuit. The computer C can obtain the program P via the storage medium M. Alternatively, the program P can be transmitted via a transmission medium. Examples of such a transmission medium encompass a communication network and a broadcast wave. The computer C can also obtain the program P via the transmission medium.

[Supplementary Remarks 1]

The present invention is not limited to the example embodiments, but can be altered by a skilled person in the art within the scope of the claims. The present invention also encompasses, in its technical scope, any embodiment derived by combining technical section disclosed in differing embodiments.

[Supplementary Remarks 2]

Some or all of the above embodiments can be described as below. Note, however, that the present invention is not limited to aspects described below.

(Supplementary Note 1)

A learning data extracting apparatus including: an issuing means that issues a network service use request which is to be processed by cooperation of a plurality of communication apparatuses constituting a control plane; an obtaining means that obtains, as pieces of candidate learning data, time series data of information relating to the plurality of communication apparatuses, the time series data being obtained in a period in which a process in response to the network service use request is carried out; and an extracting means that extracts, as data-for-machine-leaning, a piece of candidate learning data with which the process in response to the network service use request has been successfully ended, from among the pieces of candidate learning data.

(Supplementary Note 2)

The learning data extracting apparatus described in Supplementary Note 1, wherein: the extracting means further extracts, as data-for-machine-leaning, a piece of candidate learning data with which the process in response to the network service use request has been abnormally ended, from among the pieces of candidate learning data, and respectively assigns, to the data-for-machine-leaning that is the piece of candidate learning data with which the process has been successfully ended and the data-for-machine-leaning that is the piece of candidate learning data with which the process has been abnormally ended, labels each indicating a state of the control plane in response to the network service use request.

(Supplementary Note 3)

The learning data extracting apparatus described in Supplementary Note 2, wherein: the extracting means does not extract, as data-for-machine-leaning, a piece of candidate learning data with which no response has been given in response to the network service use request, from among the pieces of candidate learning data.

(Supplementary Note 4)

The learning data extracting apparatus described in Supplementary Note 1 or 2, wherein: the information relating to the plurality of communication apparatuses is traffic information of the plurality of communication apparatuses.

(Supplementary Note 5)

The learning data extracting apparatus described in Supplementary Note 1 or 2, wherein: the information relating to the plurality of communication apparatuses is statistical information relating to processes of the plurality of communication apparatuses.

(Supplementary Note 6)

The learning data extracting apparatus described in Supplementary Note 1 or 2, wherein: the issuing means adjusts an issuance status of the network service use request in accordance with an operation status of one or more communication terminals that utilize a network service.

(Supplementary Note 7)

The learning data extracting apparatus described in Supplementary Note 6, wherein: the issuing means adjusts a frequency of issuance of the network service use request in accordance with the number of times that the one or more communication terminals give the network service use request.

(Supplementary Note 8)

The learning data extracting apparatus described in Supplementary Note 1 or 2, wherein: the issuing means adjusts an issuance status of the network service use request in accordance with time information.

(Supplementary Note 9)

An inference apparatus including: a generating means that generates a learned model by carrying out machine learning with use of time series data of information relating to a plurality of communication apparatuses constituting a control plane, the time series data being obtained in a period in which a process in response to a network service use request to be processed by cooperation of the plurality of communication apparatuses is carried out; and a determining means that determines states of the plurality of communication apparatuses by inputting the time series data to the learned model.

(Supplementary Note 10)

A learning data extracting method including: issuing a network service use request which is to be processed by cooperation of a plurality of communication apparatuses constituting a control plane; obtaining, as pieces of candidate learning data, time series data of information relating to the plurality of communication apparatuses, the time series data being obtained in a period in which a process in response to the network service use request is carried out; and extracting, as data-for-machine-leaning, a piece of candidate learning data with which the process in response to the network service use request has been successfully ended, from among the pieces of candidate learning data.

(Supplementary Note 11)

A learning data extracting system including: an issuing means that issues a network service use request which is to be processed by cooperation of a plurality of communication apparatuses constituting a control plane; an obtaining means that obtains, as pieces of candidate learning data, time series data of information relating to the plurality of communication apparatuses, the time series data being obtained in a period in which a process in response to the network service use request is carried out; and an extracting means that extracts, as data-for-machine-leaning, a piece of candidate learning data with which the process in response to the network service use request has been successfully ended, from among the pieces of candidate learning data.

(Supplementary Note 12)

A program causing a computer to execute: a process of issuing a network service use request which is to be processed by cooperation of a plurality of communication apparatuses constituting a control plane; a process of obtaining, as pieces of candidate learning data, time series data of information relating to the plurality of communication apparatuses, the time series data being obtained in a period in which a process in response to the network service use request is carried out; and a process of extracting, as data-for-machine-leaning, a piece of candidate learning data with which the process in response to the network service use request has been successfully ended, from among the pieces of candidate learning data.

(Supplementary Note 13)

A learning data extracting apparatus including at least one processor, the at least one processor being configured to execute: a process of issuing a network service use request which is to be processed by cooperation of a plurality of communication apparatuses constituting a control plane; a process of obtaining, as pieces of candidate learning data, time series data of information relating to the plurality of communication apparatuses, the time series data being obtained in a period in which a process in response to the network service use request is carried out; and a process of extracting, as data-for-machine-leaning, a piece of candidate learning data with which the process in response to the network service use request has been successfully ended, from among the pieces of candidate learning data.

Note that the learning data extracting apparatus may further include a memory. In the memory, a program causing the processor to execute the process of issuing, the process of obtaining, and the process of extracting may be stored. The program may can be stored in a non-transitory, tangible storage medium capable of being read by a computer.

(Supplementary Note 14)

An inference apparatus including at least one processor, the at least one processor being configured to execute: a process of generating a learned model by carrying out machine learning with use of time series data of information relating to a plurality of communication apparatuses constituting a control plane, the time series data being obtained in a period in which a process in response to a network service use request to be processed by cooperation of the plurality of communication apparatuses is carried out; and a process of determining states of the plurality of communication apparatuses by inputting the time series data to the learned model.

Note that the inference apparatus may further include a memory. In the memory, a program causing the processor to execute the process of generating and the process of determining may be stored. The program may can be stored in a non-transitory, tangible storage medium capable of being read by a computer.

### REFERENCE SIGNS LIST

1: Learning data extracting apparatus
2, 5: Inference apparatus
4: Active probe
6: C-plane
11: Issuing section
12: Obtaining section
13: Extracting section
21: Generating section
22: Determining section
31: UE
41: Service request section
42: Request result determining section
43: Request result transmitting section
61: AMF
62: SMF
63: NSSF
64: NEF
71: RAN
72: UPF
73: DN
74: Traffic/statistical information collecting section
75: Label generating/assigning section
76: Learning data extracting section
77: Preprocessing section
100, 100A: Learning data extracting system

1. A learning data extracting apparatus comprising at least one processor,
the at least one processor being configured to execute:
a process of issuing a network service use request which is to be processed by cooperation of a plurality of communication apparatuses constituting a control plane;
a process of obtaining, as pieces of candidate learning data, time series data of information relating to the plurality of communication apparatuses, the time series data being obtained in a period in which a process in response to the network service use request is carried out; and
a process of extracting, as data-for-machine-leaning, a piece of candidate learning data with which the process in response to the network service use request has been successfully ended, from among the pieces of candidate learning data.

2. The learning data extracting apparatus according to claim 1, wherein:
in the process of extracting, the at least one processor is configured to:
further extract, as data-for-machine-leaning, a piece of candidate learning data with which the process in response to the network service use request has been abnormally ended, from among the pieces of candidate learning data; and
respectively assign, to the data-for-machine-leaning that is the piece of candidate learning data with which the process has been successfully ended and the data-for-machine-leaning that is piece of candidate learning data with which the process has been abnormally ended, labels each indicating a state of the control plane in response to the network service use request.

3. The learning data extracting apparatus according to claim 2, wherein:
in the process of extracting, the at least one processor is configured not to extract, as data-for-machine-leaning, a piece of candidate learning data with which no response has been given in response to the network service use request, from among the pieces of candidate learning data.

4. The learning data extracting apparatus according to claim 1, wherein:
the information relating to the plurality of communication apparatuses is traffic information of the plurality of communication apparatuses.

5. The learning data extracting apparatus according to claim 1, wherein:
the information relating to the plurality of communication apparatuses is statistical information relating to processes of the plurality of communication apparatuses.

6. The learning data extracting apparatus according to claim 1, wherein:
in the process of issuing, the at least one processor is configured to adjust an issuance status of the network service use request in accordance with an operation status of one or more communication terminals that utilize a network service.

7. The learning data extracting apparatus according to claim 6, wherein:
in the process of issuing, the at least one processor is configured to adjust a frequency of issuance of the network service use request in accordance with the number of times that the one or more communication terminals give the network service use request.

8. The learning data extracting apparatus according to claim 1, wherein:
in the process of issuing, the at least one processor is configured to adjust an issuance status of the network service use request in accordance with time information.

9. An inference apparatus comprising at least one processor,
the at least one processor being configured to execute:
a process of generating a learned model by carrying out machine learning with use of time series data of information relating to a plurality of communication apparatuses constituting a control plane, the time series data being obtained in a period in which a process in response to a network service use request to be processed by cooperation of the plurality of communication apparatuses is carried out; and
a process of determining states of the plurality of communication apparatuses by inputting the time series data to the learned model.

10. A learning data extracting method comprising:
issuing a network service use request which is to be processed by cooperation of a plurality of communication apparatuses constituting a control plane;
obtaining, as pieces of candidate learning data, time series data of information relating to the plurality of communication apparatuses, the time series data being obtained in a period in which a process in response to the network service use request is carried out; and
extracting, as data-for-machine-leaning, a piece of candidate learning data with which the process in response to the network service use request has been successfully ended, from among the pieces of candidate learning data.

11. The learning data extracting method according to claim 10, wherein:
the extracting is carried out such that:
from among the pieces of candidate learning data, a pieces of candidate learning data with which the process in response to the network service use request has been abnormally ended is further extracted as data-for-machine-leaning, and
labels each indicating a state of the control plane in response to the network service use request are respectively assigned to the data-for-machine-leaning that is the piece of candidate learning data with which the process has been successfully ended and the data-for-machine-leaning that is the piece of candidate learning data with which the process has been abnormally ended.

12. The learning data extracting method according to claim 11, wherein:
the extracting is carried out such that a piece of candidate learning data with which no response has been given in response to the network service use request is not extracted as data-for-machine-leaning, from among the pieces of candidate learning data.

13. The learning data extracting method according to claim wherein:
the information relating to the plurality of communication apparatuses is traffic information of the plurality of communication apparatuses.

14. The learning data extracting method according to claim 10, wherein:
the information relating to the plurality of communication apparatuses is statistical information relating to processes of the plurality of communication apparatuses.

15. The learning data extracting method according to claim 10, wherein:
the issuing is carried out such that an issuance status of the network service use request is adjusted in accordance with an operation status of one or more communication terminals that utilize a network service.

16. The learning data extracting method according to claim 15, wherein:
the issuing is carried out such that a frequency of issuance of the network service use request is adjusted in accordance with the number of times that the one or more communication terminals give the network service use request.

17. The learning data extracting method according to claim wherein:
the issuing is carried out such that an issuance status of the network service use request is adjusted in accordance with time information.
